(19) United States
(12) Patent Application Publication
(10) Pub. No.: US 2010/0333192 A1
(43) Pub. Date: Dec. 30, 2010

(54) Secure storage

(75) Inventor: May Wah Song, Singapore (SG)

Correspondence Address: SAILE ACKERMAN LLC, 28 DAVIS AVENUE, POUGHKEEPSIE, NY, 12603, US

(73) Assignee: ESGW Holdings Limited

(21) Appl. No.: 12/456,924

(22) Filed: Jun. 24, 2009

(51) Int. Cl. G06F 12/14

(52) U.S. Cl. 726/16

(57) ABSTRACT

A portable security storage unit is described, which comprises a firewall, access to networks and a hard drive external to a computer. A hard drive manager allows access to the external hard drive and provides encryption, decryption of data passing to and from the external hard drive as well as restore capability. The computer, which hosts the storage security unit, is coupled to the storage security unit by a USB connection, and the firewall and the hard drive manager are USB connected internal to the security storage unit.

### BACKGROUND OF THE INVENTION

1. Field of Invention

The present invention is related to a storage device external to a computer and in particular to an external secure storage comprising a hard drive and a firewall connected network.

2. Description of Related Art

In todays computing world it is essential to have a network connection to computers. The networks are predominately wide area networks (WAN) and local area networks (LAN). The connection to the networks is often through an Ethernet connection (E10/100/1000). Equally important is the use of a firewall to prevent unauthorized access to the computer from the networks, which can be in the form of hardware, a software program or some combination thereof.

The ever-increasing speed at which computers operate and the increasing size of programs that create and operate on computed data places a demand on disk storage space. Backing up the data and programs is an essential security measure to insure that recovery from a problem can be timely and complete. This necessitates the use of a large external hard drive to assure independence from a computer, which has developed a problem.

U.S. Pat. No. 7,346,924 B2 (Miyawaki et al.) is directed to firewalls installed on servers and storage devices to remove a security vulnerability and eliminate unauthorized access by spooling. U.S. Pat. No. 7,346,670 B2 (Kitani et al.) directed to a secure storage system for accessing a storage device on a network and improving volume management scalability. In U.S. Pat. No. 7,216,362 B1 (Strongin et al.) a system and method is directed to enhanced security and manageability using a secure storage. Memory transactions are passed to the memory by a crypto-processor. U.S. Pat. No. 6,959,390 B1 (Challener et al.) is directed to a system and method for maintaining secure user private keys in a non-secure storage device. The user private key is encrypted using a master key. U.S. Pat. No. 6,587,949 B1 (Steinberg) is directed to a secure storage device for securing digital data from a source, such as a digital camera, into a removable storage device. The digital data is stored in the secure storage device after performing one or more security functions, i.e. encryption, creating an authentication file and adding data to image files. The secure processes are transparent to the host device receiving the secure data.

In U.S. Pat. No. 5,960,177 (Tanno) a remote operating system is directed for use in a network environment in which a first unit provides remote operating services and a second unit receives the services safeguarded by a firewall. A security check by the firewall is transferred to the first unit to allow completion of a transfer of data. In U.S. Pat. No. 5,944,823 (Jade et al.) a firewall is directed to isolating a computer and network resources. A special tunneling mechanism is provided to allow communication to the computer from without by trusted individuals or objects and applications. In U.S. Pat. No. 5,748,744 (Levy et al.) a system and method is directed to securing data on a mass storage device using encryption and access keys.

Combining into a single unit external to a computing system, a hard drive with data security and a firewall connected Ethernet provides to users of the computing systems a means for managing and controlling data in secure fashion. It places in one physical unit separate from a computer the capability to communicate external to the computing system and provides secure back up of data produced by the computing system.

### SUMMARY OF THE INVENTION

It is an objective of the present invention to provide in a single portable unit separate from a computer, a data repository and a connection capability to networks external of the computer.

It is also an objective of the present invention to provide the network connection capability with a hardware firewall to prevent unauthorized access.

It is further an object of the present invention to provide a storage manager that provides data encryption, data decryption and data restoration.

In the present invention a portable storage unit containing network access and a firewall is described. The portable storage and network access unit has dimensions of approximately 152.5×81.5×25.0 millimeters. Network access is provided through an Ethernet E10/100/1000 connector, which is connected to a firewall, and the connection to a host computer, which is provided through a USB 2.0 (universal service bus) port. A link chip connects the firewall to a USB hub, which is further connected to the host computer through the USB 2.0 port. The USB hub further connects to a hard drive manager, which provides data encryption/decryption, restore and hard drive management.

In the preferred embodiment a Moschip Semiconductor MCS8140 is adapted to perform as a network USB processor, provides the firewall function and hard drive management. Since the MCS8140 is a USB connected device, a USB to SATA (serial advanced technology attachment) bridge is used to connect a hard drive with a SATA connection to the hard drive manager performed within the MCS8140 device.

Thus, the present invention provides a secure storage unit, comprising a portable external hard drive with firewall protected network access, wherein the secure storage unit is coupled to a computer through an USB connection. The firewall protection is contained within the portable secure storage unit and is independent of any firewall that is contained within the computer to which the portable storage unit is attached. Further the hard drive of the portable secure storage unit has encryption and decryption capability to protect data stored on the hard drive. Porting the secure storage unit to any computer and accessing data on the hard drive in a partition that has been encrypted requires the user to enter an encryption key defined when the hard drive was originally formatted. If the encryption key is lost or forgotten, then the only way to use that portion of the hard drive that was previously encrypted is to reformat the hard drive.

The secure storage unit disclosed herein is independent of the computer to which it is attached and performs data security independent to the computer to which it is attached. It should be noted that when the hard drive is initially formatted and partitioned that some partitions may be left free of encryption while other partitions are encrypted; and, therefore, the unencrypted partitions can be accessed from any computer to which the portable external hard drive is connected without the use of an encryption key.

### BRIEF DESCRIPTION OF THE DRAWINGS

This invention will be described with reference to the accompanying drawings, wherein:

FIGS. 1A and 1B are diagrams of the physical structure of the portable security storage unit of the present invention; and

FIG. 2 is a block diagram of the portable security storage unit of the present invention.

### DETAILED DESCRIPTION OF THE PREFERRED EMBODIMENT

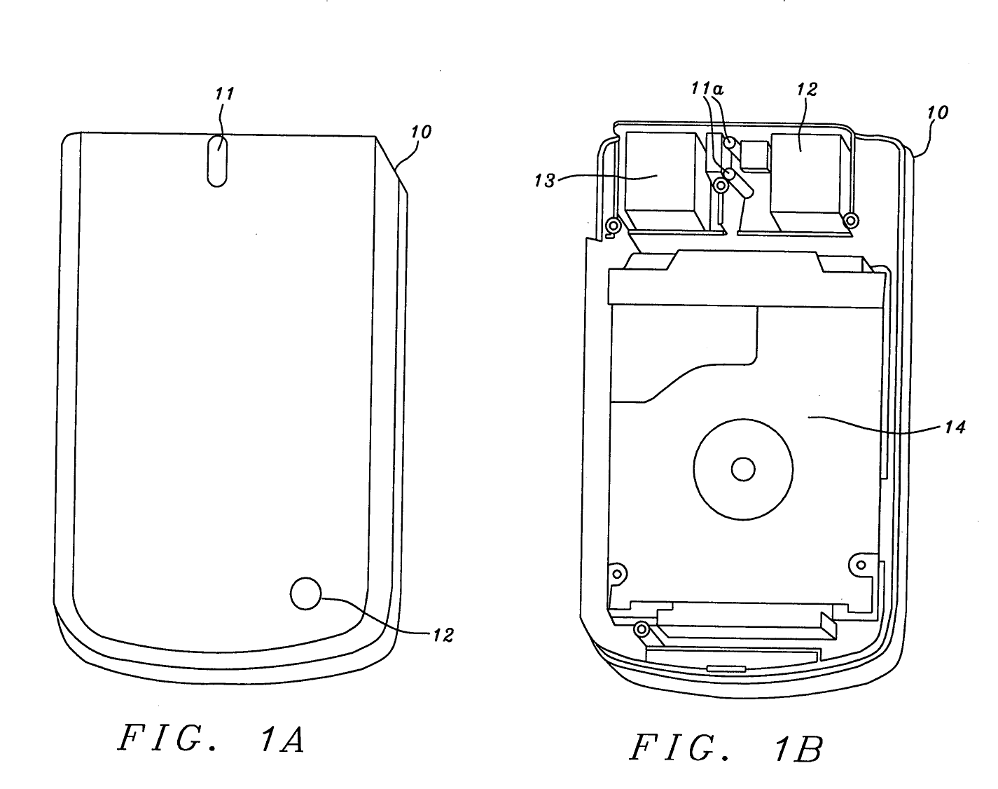

In FIG. 1A is diagram of the closed package 10 of the portable security storage unit of the present invention with dimensions of approximately 152.5×81.5×25.0 millimeters. The portable security storage unit comprising a security engine containing a firewall and a hard drive manager. Shown on the top surface is an activity indicator 11 and an on/off button 12. The small size provides for ease of portability and allows the security storage unit 10 to be transported and used with different host computers.

In FIG. 1B is a diagram of the portable security storage unit 10 with the cover removed. Two activity indicator lights 11a are shown between the Ethernet E10/100/1000 and the USB connector housings 12 and 13. The USB connector is used to connect the portable secure storage unit to a computer. A hard drive 14 defines most of the required space for the security storage unit 10.

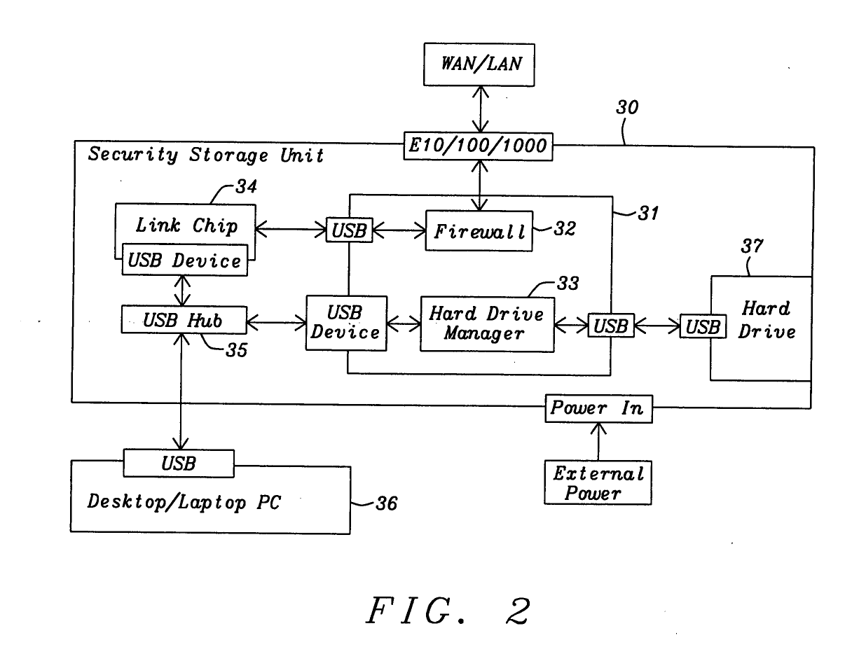

In FIG. 2 is shown a block diagram of the portable security storage unit of the present invention. The security storage unit 30 comprises a network USB processor 31, for example an MCS8140 produced by Moschip semiconductor. The network USB processor further comprises a firewall 32 and a hard drive manager 33. A external network comprising a WAN (wide area network) or a LAN (local area network) is connected to an Ethernet E10/100/1000 port of the portable security unit 30, which feeds external signals to the firewall 32. External signals not blocked by the firewall 32 are connected to a link chip 34 through a USB port of the network USB processor. The link chip 34 uses a USB connection to connect external WAN/LAN signals through a USB hub 35 to a desktop/laptop computer 36.

Data from a desktop/laptop PC 36 is stored in the hard drive 37 by routing the data to the USB hub 35, which connects the data to hard drive manager 33 through a USB device. If the data is to be stored in an encrypted partition, the hard drive manager 33 encrypts the data from the desktop/laptop PC 36 and stores the encrypted data into the hard drive 37 through a USB connection. The hard drive manager also provides decryption and restoration operations for the data stored in the hard drive 37 in storage partitions that were encrypted when the hard drive was initially formatted. In order to access, or store, data in an encrypted partition, an encryption key must be used by the user. In any partition that was not encrypted during the initial formatting of the hard drive, data access can be performed from any computer to which the portable security storage unit is attached without the use of an encryption key. It should be noted that if the hard drive uses a SATA (serial advanced technology attachment) for data communications, a SATA/USB bridge is used to communicate between the network USB processor 31 and the hard drive 37.

When the desktop/laptop PC 36 requests data from the hard drive 37, the request is made to the hard drive manager 33, which addresses the data in the hard drive 37. If the partition in which the data resides is encrypted, the user enters an encryption key, and the hard drive manager 33 decrypts the data before coupling the data to the desktop/laptop PC. If the partition in which the data resides is not encrypted, the hard drive manager 33 accesses the data without the need for an encryption key. In either case, encrypted partition or unencrypted partition, the hard drive manager 33 delivers the requested data to the connected PC 36 through the USB hub 35 and the USB connection to the connected PC 36.

It should be noted that the storage security unit can be integrated into the desktop/laptop PC and perform the same functions the portable storage security unit as describe herein.

While the invention has been particularly shown and described with reference to preferred embodiments thereof, it will be understood by those skilled in the art that various changes in form and details may be made without departing from the spirit and scope of the invention.

What is claimed is:

1. An external security storage device, comprising:
a) a security storage device externally coupled to a computer;
b) said security storage device further comprising:
i) a hard drive,
ii) a hard drive manager,
iii) a firewall, and
iv) a network connection;
c) said firewall operates independent of said computer and blocks unwanted access from said network connection; and
d) said hard drive manager partitions said hard drive into encrypted and non-encrypted partitions, and controls access to the hard drive, wherein an encryption key is required to access data in the encrypted partition.

2. The external security storage device of claim 1, wherein said security storage device coupled to the computer through an USB hub.

3. The external security storage device of claim 2, wherein said USB hub couples said network connection monitored by said firewall to said computer.

4. The external security storage device of claim 1, wherein said network connection provided by an Ethernet connection.

5. The external security storage device of claim 1, wherein said hard drive disk manager coupled to said hard disk drive through an USB connection.

6. The external security storage device of claim 4, wherein said hard drive disk manager coupled to said hard drive through a SATA (serial advanced technology attachment) connection.

7. A method of forming a secure external storage unit, comprising:
a) forming a security storage unit external to a computer, which further comprises a hard drive and a firewall;
a) coupling said hard drive to a hard drive manager;
b) coupling said firewall to an Ethernet connection;
c) coupling said hard drive manager and said firewall to a USB hub; and
d) coupling said USB hub to a computer.

8. The method of claim 6, wherein said hard drive manager is coupled to the hard drive with a USB connection.

9. The method of claim 6, wherein said hard drive manager is coupled to the hard drive with a SATA (serial advanced technology attachment) connection.

10. The method of claim 6, wherein said hard drive accessible from a network through the firewall.

11. A secure portable external storage device, comprising:
a) a means for an external hard drive and a firewall combined in a device external to a computer;
b) a means for coupling said external hard drive to said computer;
c) a means for coupling a network to said firewall;
d) a means for coupling said firewall to said computer; and
e) said means for said external hard drive further comprises a controller means for encryption, decryption and file restore.

12. The portable secure storage device of claim 11, wherein the means for coupling said network is by an Ethernet connection.

13. The portable secure storage device of claim 11, wherein the means for coupling said external hard drive and said firewall to said computer is an USB hub within said package.

14. The portable secure storage device of claim 11, wherein the means for coupling the external hard drive to the computer further comprises the controller coupled to the external hard drive using a SATA (serial advanced technology attachment) connection.

15. The portable secure storage device of claim 11, wherein the means for coupling the external hard drive to the computer further comprises the controller coupled to the external hard drive using an USB connection.

16. The portable secure storage device of claim 11, wherein said device is portable between computers.
